(19) United States
(12) Patent Application Publication
(10) Pub. No.: US 2005/0231447 A1
(43) Pub. Date: Oct. 20, 2005

(54) Pixel arrangement in a display system

(76) Inventors: Shuo-Hsiu Hu, Tainan City (TW); Chih-Feng Sung, Miaoli City (TW)

Correspondence Address: David I. Roche;BAKER & McKENZIE, 130 E. Randolph Drive, Chicago, IL, 60601, US

(21) Appl. No.: 10/824,008

(22) Filed: Apr. 14, 2004

(51) Int. Cl. G09G 3/20

(52) U.S. Cl. 345/76

(57) ABSTRACT

A pixel array comprises a plurality of display areas where light is irradiated to achieve image display. The display areas of one row of pixels form a nonuniform distribution along the corresponding scan line so as to reduce the visual appearance of the dark lines created by dark areas between two adjacent rows of pixels.

### FIELD OF THE INVENTION

The present invention relates generally to display systems, and more particularly to a display system provided with a pixel arrangement that can improve the image quality.

### DESCRIPTION OF THE RELATED ART

Regardless of its particular construction, a display panel generally includes an array of pixels respectively operable to irradiate light of different colors and/or gray scale levels to display images. Conventionally, scan lines and data lines cross the pixel array in perpendicular directions to deliver the necessary electrical signals to select and switch each pixel to the adequate illuminated or extinguished state. The electrical signals from the scan and data lines reach an electrical addressing device coupled with each pixel. According to the specific signals received, the electrical addressing device accordingly switches the pixel to the adequate illumination state. The areas encompassing the scan lines, the data lines and the electrical addressing devices constitute dark or non-display areas of the pixel array.

In a color display panel, each pixel is further divided into a number of color subpixels distributed uniformly in alignment along the pixel row. Each of the subpixels is coupled with one electrical addressing device. The multiplication of subpixels to improve the display color definition, which consequently increases the number of electrical addressing devices, conventionally results in an increase of the non-display areas in the pixel array. As shown in FIG. 1, these non-display areas may be particularly visible as dark lines 120 between two adjacent rows of pixels 130 in a pixel array 100, wherein reference numeral 132 designates the display areas of the pixels 130. The visual appearance of the dark lines 120 undesirably deteriorates the image quality of the display panel.

Therefore, there is presently a need for a display system that can overcome the above disadvantages and provides an improved image quality of the display panel.

### SUMMARY OF THE INVENTION

The present application describes the layout of a display pixel array. The pixel array comprises at least one scan line, a plurality of data lines, a plurality of pixels, each pixel including one or more color subpixels, and a plurality of electrical addressing devices respectively coupling each color subpixel to the at least one scan line and one of the data lines, wherein the one or more color subpixels include display areas arranged according to a nonuniform distribution along the at least one scan line. The nonuniform distribution of the display areas reduces the visual appearance of the dark lines created by dark or non-display areas between two pixel rows.

In an embodiment, the layout of the display pixel array is implemented in an electroluminescent display, and one or more color subpixels respectively includes one light-emitting device coupled with one electrical addressing device. In another embodiment, the layout of the display pixel array is implemented in a liquid crystal display, and one or more color subpixel includes one display electrode coupled with one electrical addressing device.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1 is a schematic view of a conventional pixel array of a display panel;

FIG. 2A is a circuit diagram of a pixel array implemented according to an embodiment of the invention;

FIG. 2B is a schematic planar view of a pixel layout implemented in an electroluminescent display according to an embodiment of the invention;

FIG. 2C is a schematic view generally illustrating the distribution of the display areas in a pixel array implemented according to an embodiment of the invention;

FIG. 2D is a schematic planar view of a pixel layout implemented in an electroluminescent display according to a variant embodiment of the invention;

FIG. 2E is a schematic view generally illustrating the distribution of the display areas in a pixel array implemented according to another embodiment of the invention;

FIG. 3A is a schematic planar view of a pixel layout implemented in a liquid crystal display according to an embodiment of the invention;

FIG. 3B is a cross-sectional view of a pixel cell of a liquid crystal display according to an embodiment of the invention; and

FIG. 3C is a schematic planar view of a pixel array implemented in a liquid crystal display according to another embodiment of the invention.

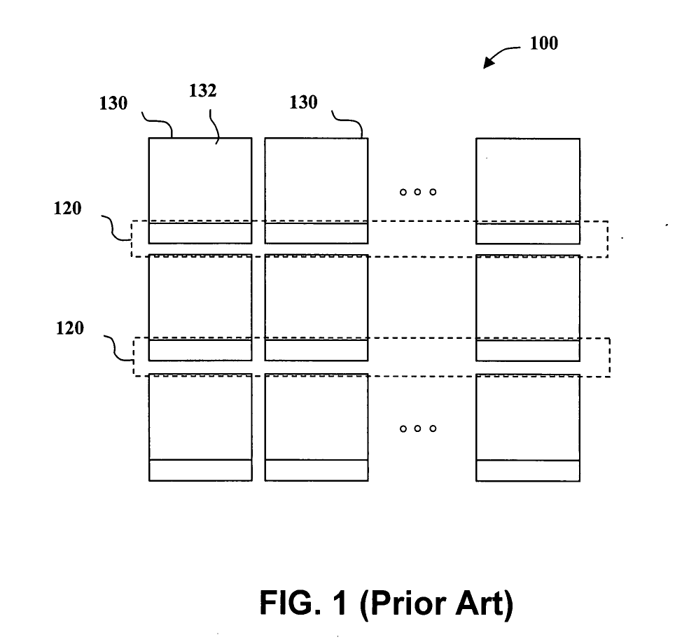

### DETAILED DESCRIPTION OF THE EMBODIMENT(S)

The term “pixel” means an area of an image display array that can be electrically stimulated to irradiate light. The term “subpixel” means an area of a pixel which can be addressed to irradiate light of a particular color in a multicolor display. The term “multicolor” is employed to describe image displays having a plurality of pixels, and each pixel comprises at least two color subpixels each of which being operable to irradiate light of a different color.

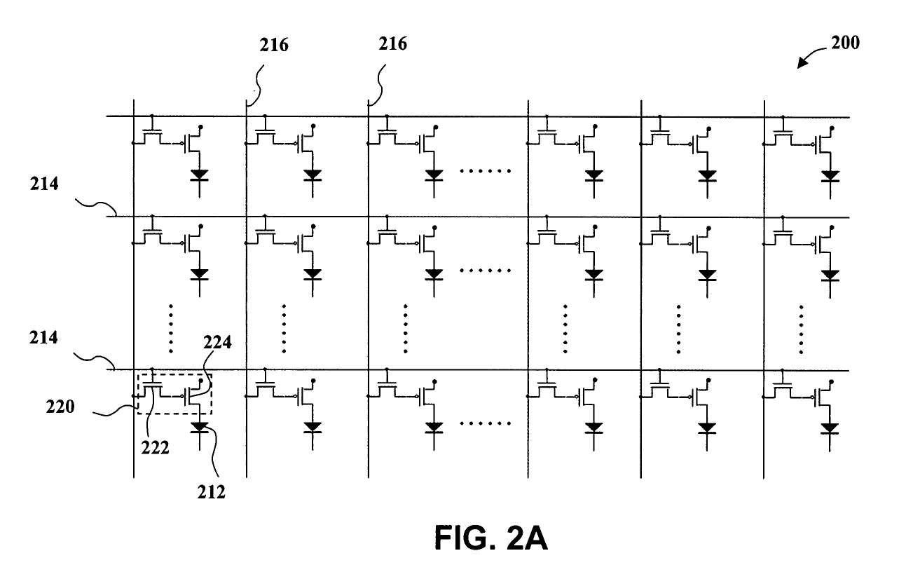

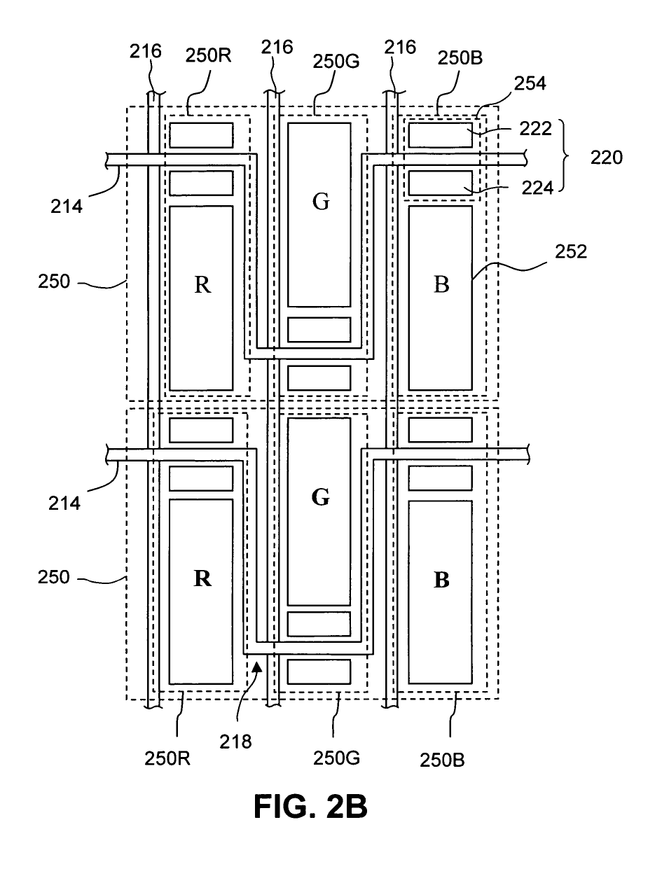

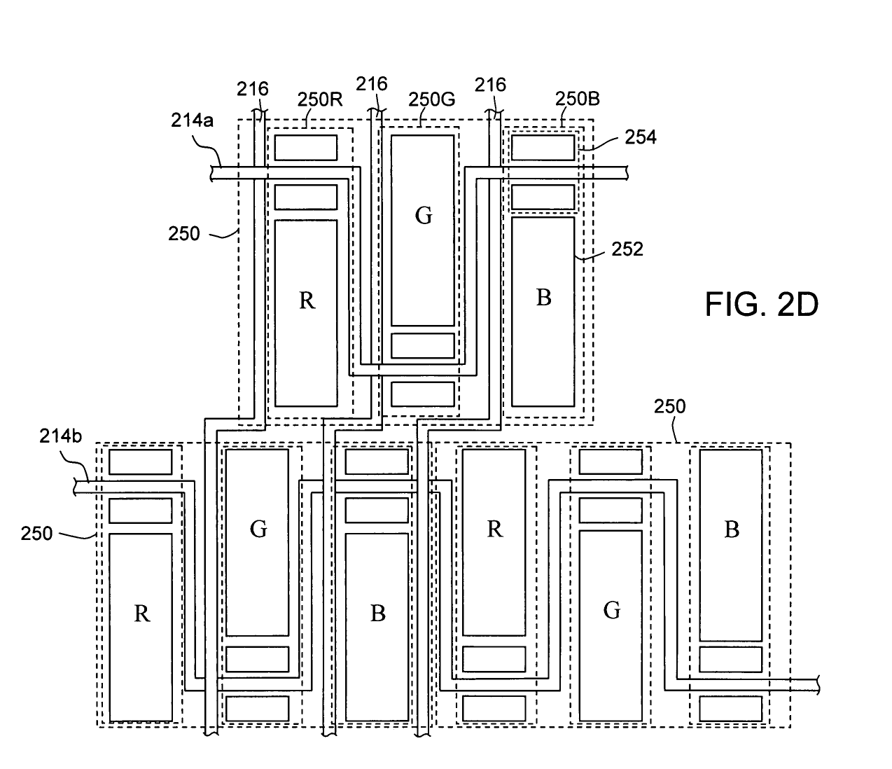

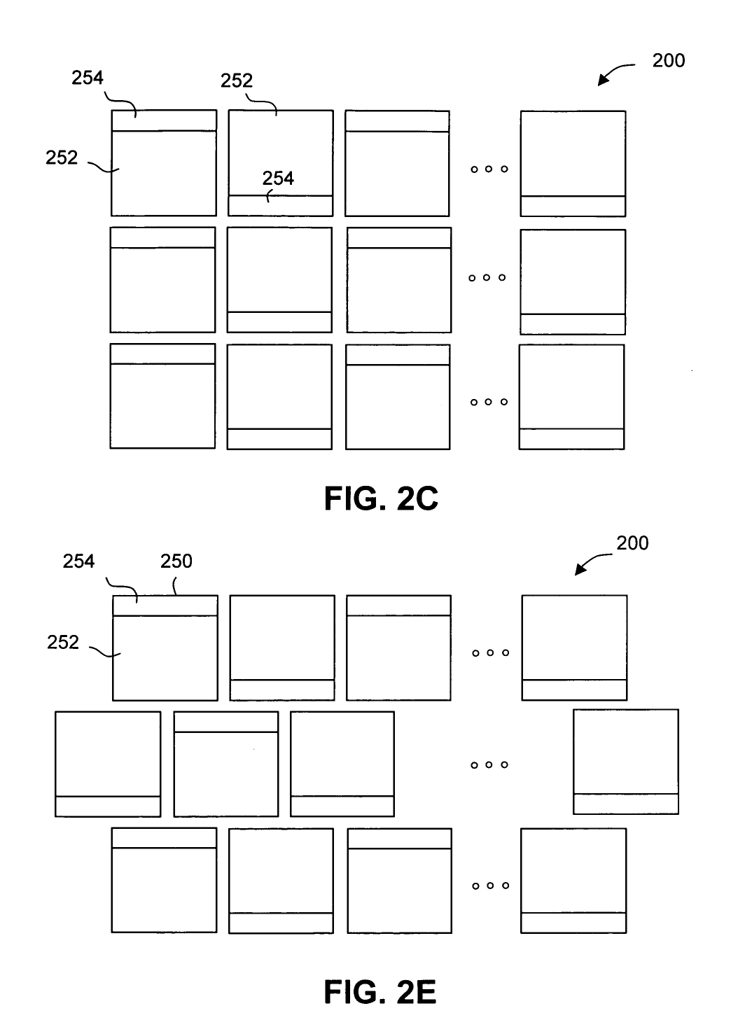

FIG. 2A is a circuit diagram of an electroluminescent display according to an embodiment of the invention. The electroluminescent display 200 includes a plurality of electroluminescent devices 212 distributed in array, and a mesh of scan lines 214 and data lines 216 along which electrical signals are delivered to select and switch the electroluminescent devices 212. The scan lines 214 and data lines 216 can be perpendicular to one another to define a pixel array. In a multicolor eletroluminescent display implementation, the electroluminescent devices 212 can be organic light-emitting diodes operable to irradiate light of different colors. An electrical addressing device 220 couples each electroluminescent device 212 to one scan line 214 and one data line 216 to electrically drive the illumination of the electroluminescent device 212, and thereby achieve image displaying.

In the example of FIG. 2A, the electrical addressing device 220 can include the coupling of two thin film transistors 222, 224. The thin film transistor 222 operates as a switch by receiving addressing and data signals from the scan and lines 214, 216, while the thin film transistor 224 operates as a driver to enable the passage of an electrical current towards the electroluminescent device 212. Notwithstanding the specific circuitry implementation illustrated, it will be understood that the invention as described herein can be generally suitable with any driving circuit designs.

FIG. 2B is a schematic view illustrating the pixel layout of the electroluminescent display according to an embodiment of the invention. In the embodiment of FIG. 2B, a pixel 250 includes a plurality of subpixels 250R, 250G, 250B. In a multicolor liquid crystal display, a tricolor base system can be exemplary implemented and the subpixels 250R, 250G, 250B can correspond to red (R), green (G), and blue (B) color subpixels, respectively. However, it will be understood that many color systems can be generally envisaged to set the number of color subpixels per pixel.

Each subpixel 250R, 250G, 250B encompasses one electroluminescent device such as organic light-emitting diode 212 coupled with one electrical addressing device 220. The light emission area of one organic light-emitting diode 212 constitutes a display area 252 of each subpixel 250R, 250G, 250B. Within one pixel 250, the display areas 252 of the subpixels 250R, 250G, 250B are offset from one another in the direction of the data lines 216. The offset arrangement of the display areas 252 results in a nonuniform distribution with differently leveled portions of the display areas 252, which breaks and reduces the visual appearance of the dark lines created by dark or non-display areas 254 across the pixel array, as illustrated in FIG. 2C.

In the example of FIG. 2B, the scan line 214 can be formed according to a crenelated profile to couple with the electrical addressing devices 220 of the subpixels 250R, 250G, 250B. In this distribution scheme, the display areas 252 are placed alternately at either sides of the scan line 214. However, it is understood that many configurations of the scan lines 214 can be practically implemented to achieve a nonuniform distribution of the light-emitting devices as described above.

FIG. 2D˜2E describes a variant embodiment implemented with a delta configuration of the pixel array. The delta configuration is characterized in that the position of the subpixels 250R, 250G, 250B coupled to one same scan line 214a is offset in a row direction relative to the subpixels 250R, 250G, 250B coupled with an adjacent scan line 214b.

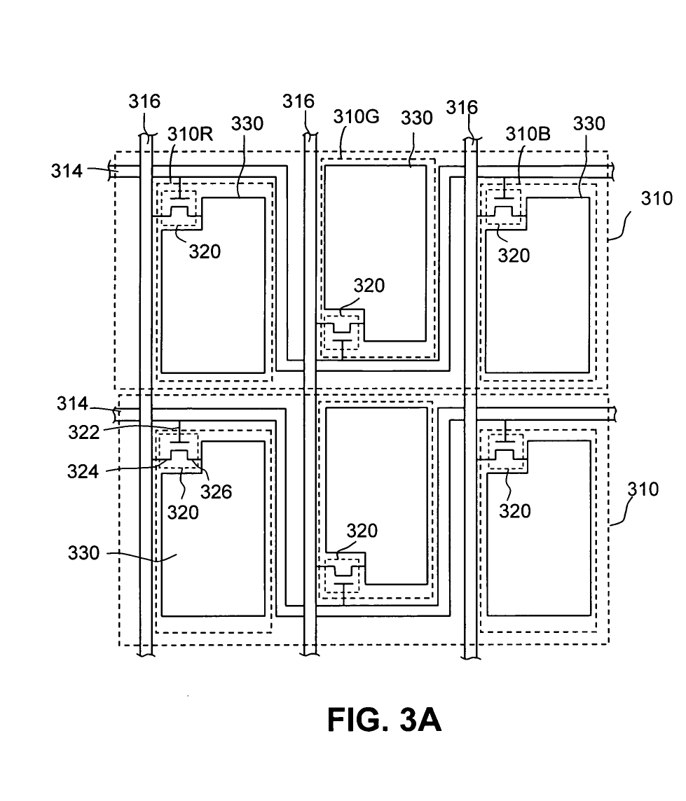

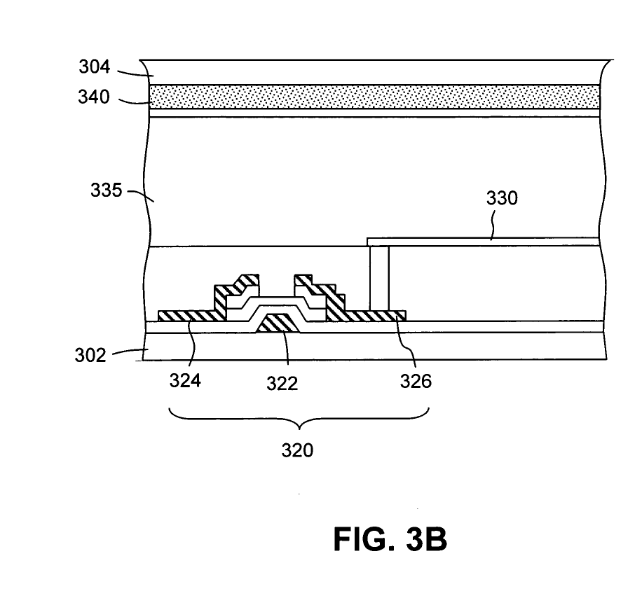

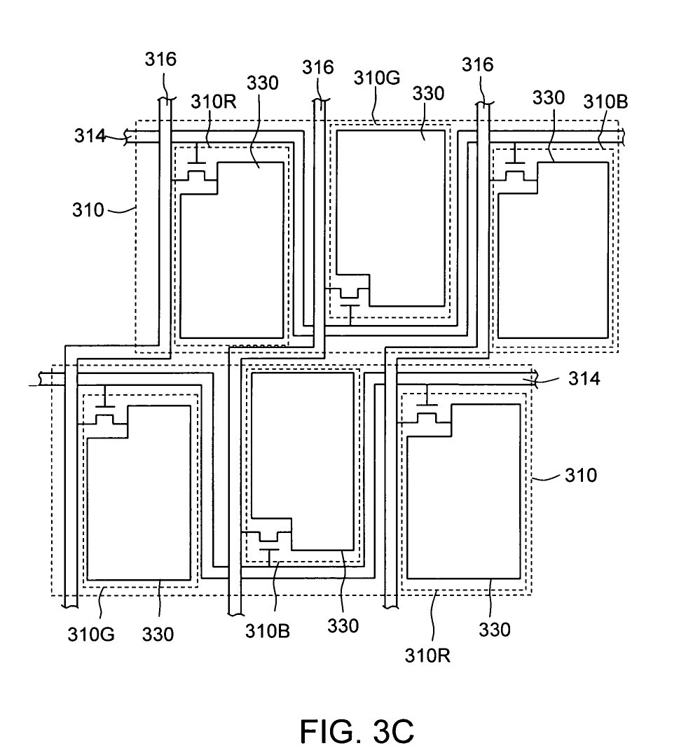

Reference now is made to FIG. 3A-3B to describe a pixel layout implemented in a liquid crystal display according to another embodiment of the invention. The pixel layout includes a mesh of scan lines 314 and data lines 316 that define an array of pixels 310. Each pixel 310 includes subpixels 310R, 310G, 310B that respectively comprise an electrical addressing device 320 connected to a display electrode 330. In a multicolor liquid crystal display, each of the subpixels 310R, 310G, 310B further includes a color filter 340 overlapping with the area of the display electrode 330.

FIG. 3B is a cross-sectional view of an implementation of a multicolor LCD according to an embodiment of the invention. The multicolor LCD includes the assembly of a liquid crystal layer 335 sandwiched between two substrates 302, 304. The color filter 340 can be formed on a surface of the front substrate 304; but alternatively the color filter may be formed at other locations such as over the rear substrate 302 (not shown). The electrical addressing device 320 can be a thin film transistor formed on the rear substrate 302, and has its gate terminal 322 connected to the at least one scan line 314, a drain terminal 324 connected to one data line 316, and a source terminal 326 connected to one display electrode 330.

Upon receiving electrical signals from one scan line 314 and one data line 316, the thin film transistor 320 is operable to apply a voltage potential to the display electrode 330 and create an electric field in the liquid crystal layer of the liquid crystal display. Image display can be thereby conducted, and the display electrode 330 constitutes a display area.

In FIG. 3A, the subpixels 310R, 310G, 310B are arranged in matrix and the nonuniform distribution of the display areas can be obtained via placing the display electrodes 330 offset from one another. In the illustrated implementation, the common scan line 314 forms a crenelated profile at two sides of which are alternately placed the display electrodes 330. FIG. 3C illustrates a variant example where the nonuniform distribution of the display electrodes can be also obtained for a delta distribution of the pixels.

It is understood that many arrangements other than the offset scheme described herein can be envisaged to achieve a nonuniform distribution with differently leveled portions of the pixel display areas. Therefore, realizations in accordance with the present invention have been described in the context of particular embodiments. These embodiments are meant to be illustrative and not limiting. Many variations, modifications, additions, and improvements are possible to implement the inventive features described herein. Accordingly, plural instances may be provided for components described herein as a single instance. Additionally, structures and functionality presented as discrete components in the exemplary configurations may be implemented as a combined structure or component. These and other variations, modifications, additions, and improvements may fall within the scope of the invention as defined in the claims that follow.

1. An electroluminescent display comprising:
at least one scan line;
a plurality of data lines;
a plurality of light-emitting devices; and
a plurality of electrical addressing devices respectively coupling each of the light-emitting devices to one data line and the at least one scan line;
wherein the light-emitting devices include display areas arranged according to a nonuniform distribution along the at least one scan line.

2. The electroluminescent display of claim 1, wherein the display areas are offset from one another in a direction approximately perpendicular to the at least one scan line.

3. The electroluminescent display of claim 1, wherein the light-emitting devices coupled with the at least one scan line include at least a first display area and a second display area having differently leveled portions.

4. The electroluminescent display of claim 1, wherein the at least one scan line forms a crenelated profile.

5. The electroluminescent display of claim 4, wherein the display areas are alternately placed at two sides of the at least one scan line formed in a crenelated profile.

6. The electroluminescent display of claim 1, wherein the light-emitting devices include organic light-emitting diodes.

7. The electroluminescent display of claim 1, wherein one or more of the electrical addressing devices includes the coupling of a switch thin film transistor and a driver thin film transistor.

8. The electroluminescent display of claim 7, wherein the switch thin film transistor is coupled to the at least one scan line and one data line to respectively receive addressing and image signals, and the driver thin film transistor is coupled to the switch thin film transistor to deliver an electric current to one light-emitting device.

9. A liquid crystal display comprising:
at least one scan line;
a plurality of data lines;
a plurality of display electrodes; and
a plurality of electrical addressing devices respectively coupling each display electrode to one data line and the at least one scan line;
wherein the display electrodes are arranged according to a nonuniform distribution along the at least one scan line.

10. The liquid crystal display of claim 9, wherein the display electrodes are offset from one another in a direction approximately perpendicular to the at least one scan line.

11. The liquid crystal display of claim 9, wherein the display electrodes coupled with the at least one scan line include at least a first display area and a second display area having differently leveled portions.

12. The liquid crystal display of claim 9, wherein the at least one scan line forms a crenelated profile.

13. The electroluminescent display of claim 12, wherein the display electrodes are alternately placed at two sides of the at least one scan line formed in a crenelated profile.

14. The liquid crystal display of claim 9, wherein one or more of the electrical addressing devices includes a thin film transistor having a gate terminal connected to the at least one scan line, a drain terminal connected to one data line, and a source terminal connected to one display electrode.

15. A display pixel array comprising:
at least one scan line;
a plurality of data lines;
a plurality of pixels, each pixel including one or more color subpixels; and
a plurality of electrical addressing devices respectively coupling each color subpixel to one data line and the at least one scan line;
wherein the color subpixels include display areas arranged according to a nonuniform distribution along the at least one scan line.

16. The pixel array of claim 15, wherein the display areas are offset from one another in a direction approximately perpendicular to the at least one scan line.

17. The pixel array of claim 15, wherein the subpixels coupled with the at least one scan line include at least a first display area and a second display area having differently leveled portions.

18. The pixel array of claim 15, wherein the at least one scan line forms a crenelated profile.

19. The pixel array of claim 18, wherein the display areas are alternately placed at two sides of the at least one scan line formed in a crenelated profile.

20. The pixel array of claim 15, wherein one or more color subpixels respectively includes one display electrode coupled with one electrical addressing device.

21. The pixel array of claim 20, wherein one or more electrical addressing device respectively includes a thin film transistor having a gate terminal connected to the at least one scan line, a drain terminal connected to one data line, and a source terminal connected to one display electrode.

22. The pixel array of claim 15, wherein one or more subpixels respectively include one light-emitting device coupled to one electrical addressing device.

23. The pixel array of claim 22, wherein one or more electrical addressing devices respectively includes the coupling of a switch thin film transistor and a driver thin film transistor.

24. The pixel array of claim 23, wherein the switch thin film transistor is coupled to the at least one scan line and one data line to respectively receive addressing and image signals, and the driver thin film transistor is coupled to the switch thin film transistor to deliver an electric current to one light-emitting device.

25. The pixel array of claim 15, wherein the pixels are arranged according to a delta configuration.
